(19) United States
(12) Patent Application Publication
(10) Pub. No.: US 2023/0051124 A1
(43) Pub. Date: Feb. 16, 2023

(54) NUCLEAR FUSION APPARATUS

(71) Applicant: Ascentool, Inc., Palo Alto, CA (US)

(72) Inventor: George Xinsheng Guo, Palo Alto, CA (US)

(21) Appl. No.: 17/819,146

(22) Filed: Aug. 11, 2022

Related U.S. Application Data
(60) Provisional application No. 63/233,265, filed on Aug. 14, 2021.

(51) Int. Cl. G21B 1/17; G21B 1/05

(52) U.S. Cl. CPC G21B 1/17; G21B 1/05

(57) ABSTRACT

A controlled nuclear fusion system includes a vacuum chamber, an electrode cage shaped in a first closed-loop tube in the vacuum chamber, wherein the electrode cage comprises electrically conductive wires configured to confine ions and electrons in the electrode cage and a toroidal electromagnetic coil coiled around outside of the electrode cage and configured to produce a closed-loop magnetic flux in the electrode cage.

### BACKGROUND OF THE INVENTION

The present application relates to a plasma vacuum chamber capable of carrying on nuclear fusions.

Nuclear fusion that involves collisions and reactions of Deuterium atoms with other Deuterium, Tritium, or Helium 3, to form Tritium, Helium 3, Helium 4 or/and neutrons or protons can generate large amount of energy. One attempted method to produce nuclear fusion is to form a plasma at adequate energy and adequate plasma density to cause enough nuclear reactions to achieve net energy gains. The confinement of plasma has been a major challenge to achieve net energy gain.

One major issue is the lack of electrodes in Tokomak types of reactors. Since the vacuum chamber walls are either grounded or floating electrically, a plasma cannot be generated inside the vacuum chamber. Instead, a plasma is induced by an external changing current, typically by the Inner Poloidal Electrical Coils in a Tokamak. When the current reaches a maximum value, new ions and electrons can no longer be generated. It is thus difficult to sustain stable plasma. Energy injection by neutral beams has low energy efficiency, the Deuterium and Tritium gas has to be ionized, accelerated, and neutralized to avoid bending of the ion beam by strong magnetic field inside Tokomak. Most ions in the ion beam are not neutralized and have to be wasted, resulting in low energy utilization.

Another major issue is the loss of ions and electrons to the vacuum walls, which drain energy from the plasma. Even if the magnetic fields are carefully designed to contain plasma, the randomized ion motions due to collisions make it hard to contain plasma by magnetic field alone. The thermal plasma motions are in every direction, only small portion of ions collides in head-on directions, which has the maximum relative energy to achieve nuclear fusion. Furthermore, the entire body of gas inside the vacuum chamber must be heated to high temperature, resulting in large convection heat loss to the wall. The heat loss due to radiation is also large due to direct radiation from the high-temperature plasma to cold vacuum chamber.

### SUMMARY OF THE INVENTION

The present application discloses a nuclear fusion system that provides stable plasma at high energy efficiency. The disclosed Tokamak includes electrodes in its interior to supply energetic ions and maintain a stable plasma. The number of ions that reach the electrodes or vacuum chamber walls are reduced. The electrode can also act as high temperature shield to reduce the radiation heat loss of the plasmas.

In one general aspect, the present invention relates to a controlled nuclear fusion system that includes a vacuum chamber, an electrode cage shaped in a first closed-loop tube in the vacuum chamber, wherein the electrode cage comprises electrically conductive wires configured to confine ions and electrons in the electrode cage and a toroidal electromagnetic coil coiled around outside of the electrode cage and configured to produce a closed-loop magnetic flux in the electrode cage.

Implementations of the system may include one or more of the following. The controlled nuclear fusion system can further include an outer poloidal magnet and an inner poloidal magnet configured to produce a plasma in presence of the closed-loop magnetic flux in the vacuum chamber. The electrode cage can include an input and an output, wherein the input and the output are separated by a gap to reduce induction current by the inner poloidal magnets. The electrode cage is configured to be negatively biased relative to the vacuum chamber to form a potential surface to confine the ions. The electrode cage can be positively biased relative to the vacuum chamber to confine the electrons inside the electrode cage. The electrode cage can be electrically connected to the vacuum chamber. The electrode cage can be electrically isolated to the vacuum chamber. The electrode cage can be electrically biased relative to the vacuum chamber by an alternating voltage to trap ions and electrons in the electrode cage. The vacuum chamber can be shaped in a second closed-loop tube, wherein the second closed-loop tube of the vacuum chamber can be nested in the first closed-loop of the toroidal electromagnetic coil. The toroidal electromagnetic coil can be coiled around outer surfaces of the vacuum chamber. The toroidal electromagnetic coil can be inside the vacuum chamber. The electrode cage can include a plurality of looped electrodes positioned in a toroidal shape to form the first closed-loop tube. The looped electrodes in the electrode cage can include a superconducting material to form the closed loop magnetic flux. The electrode cage can be formed by a conducting coil that are positioned in a toroidal shape to form the first closed-loop tube. The electrode cage can be formed by a toroidal mesh of crisscrossed conducting wires and insulating wires. The electrode cage can be formed by a toroidal mesh of conducting wires.

### BRIEF DESCRIPTION OF DRAWINGS

FIGS. 1A and 1B are respectively a perspective view and a cross-sectional perspective view of a Tokomak system in accordance with some embodiments of the present invention.

FIG. 1C illustrates an exemplified electrode cage without a Tokomak chamber compatible with the Tokomak system in FIGS. 1A and 1B.

FIGS. 1D and 1E are cross-sectional views of a Tokomak system in accordance with some embodiments of the present invention. FIG. 1D illustrates ions' movements inside a plasma. FIG. 1E illustrates electron movement inside the plasma.

FIG. 2A illustrates an exemplified individual looped electrode and its electrical connections, cooling connections, and vacuum mounting compatible with the Tokomak system in FIGS. 1A and 1B.

FIG. 2B illustrates the detailed cross section of a looped electrode and its electrical connections, cooling connections, and vacuum mounting as shown in FIG. 2A.

FIG. 2C illustrates multiple looped electrode and its electrical connections, cooling connections, and vacuum mounting as shown in FIG. 2A, placed in a circular pattern.

FIG. 2D illustrates the multiple looped electrodes in FIG. 2C inside the Tokomak.

FIGS. 2E, 2F, and 2G is a perspective cross-sectional view of a Tokomak system comprising the multiple looped electrodes in FIG. 2D in different details.

FIGS. 3A and 3B are cross-sectional views of a conductive or partially conductive mesh compatible with the Tokomak system in FIGS. 1A and 1B.

FIG. 4 illustrates individual looped electrodes placed in close proximity to each other to reduce radiation loss of the plasma compatible with the Tokomak system in FIGS. 1A and 1B.

FIG. 5 illustrates the electrode cage within a cylindrical shaped vacuum chamber in accordance with some embodiments of the present invention.

### DETAILED DESCRIPTION OF THE INVENTION

Tokamak uses strong superconducting coil magnets to confine both ions and electron and use induction current from Inner Poloidal Magnet Coils to ionize and heat up plasma. To have net energy gain, enough energy must be put into the plasma and maintain the high temperature plasma for sufficient time. The challenges are energy loss due to ions and electrons hitting the vacuum chamber walls, radiation loss from the plasma to cold vacuum chamber walls, stability of plasma, and efficiency of injecting energy into plasma. The Tokamak lacks electrodes and relies on induction heating to generate plasma. When the induction current reaches its limit, the plasma collapse and the neutralized molecules can no longer be confined by magnetic fields and lose their energy. The present invention provides a continuous plasma source and a mean to provide energy to the plasma, reduces the energy losses due to plasma hitting chamber walls, and reduces radiation losses from the higher temperature plasma to the chamber walls.

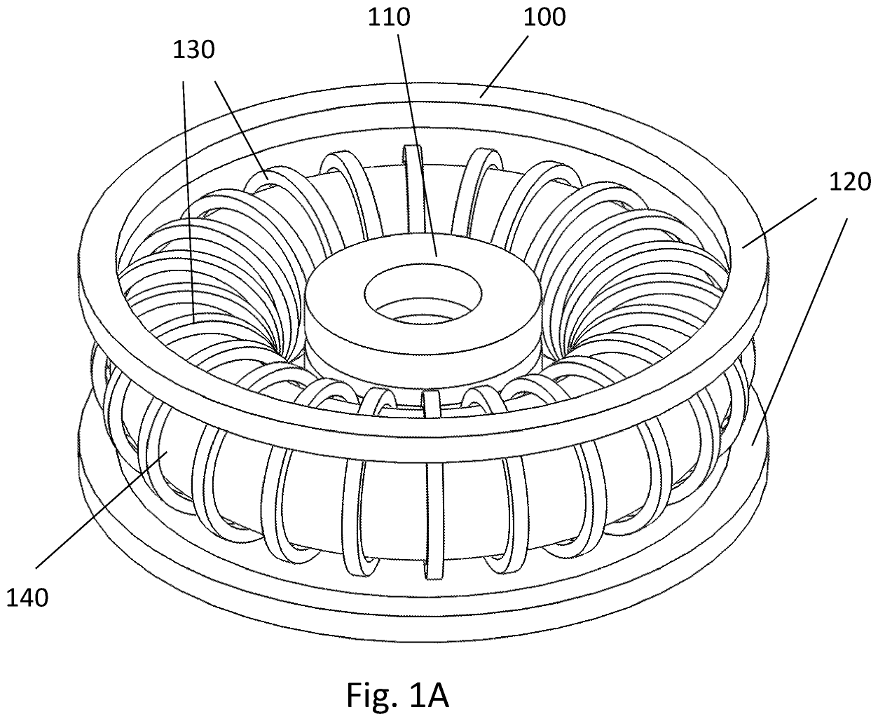

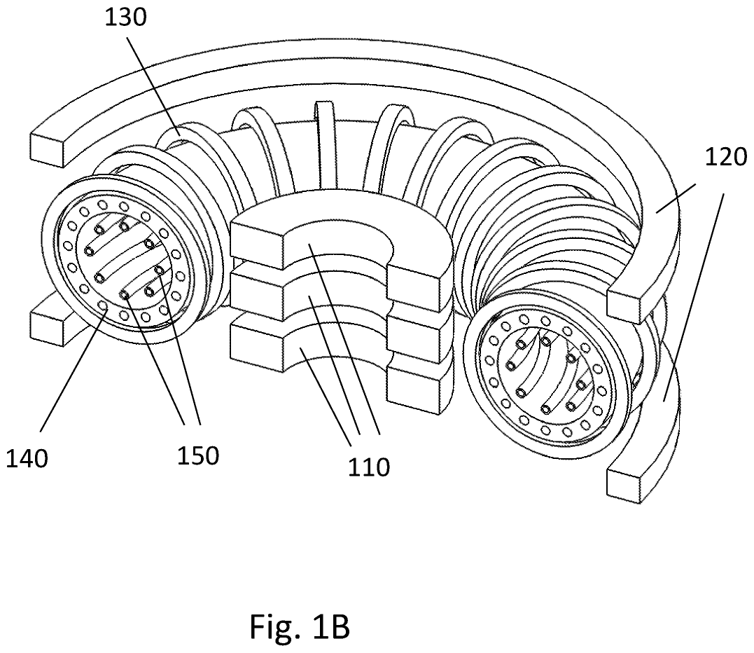

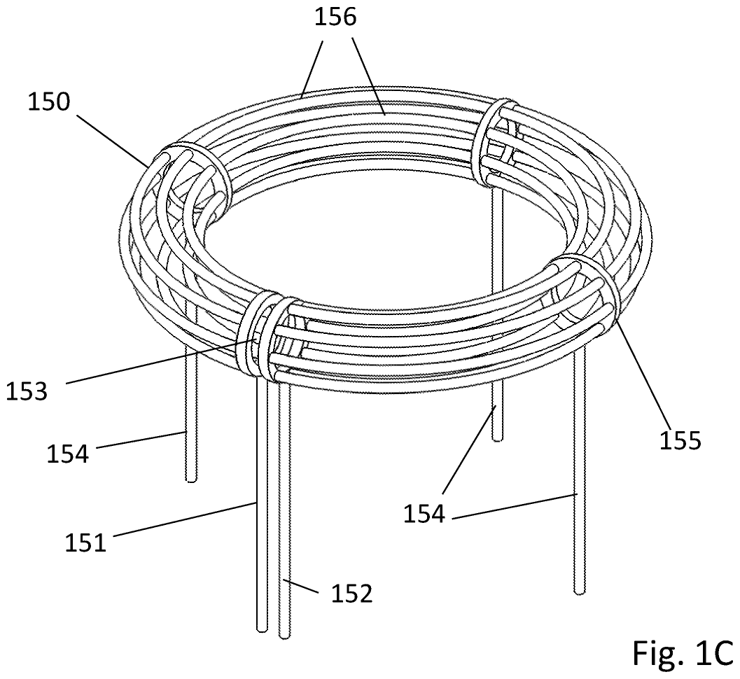

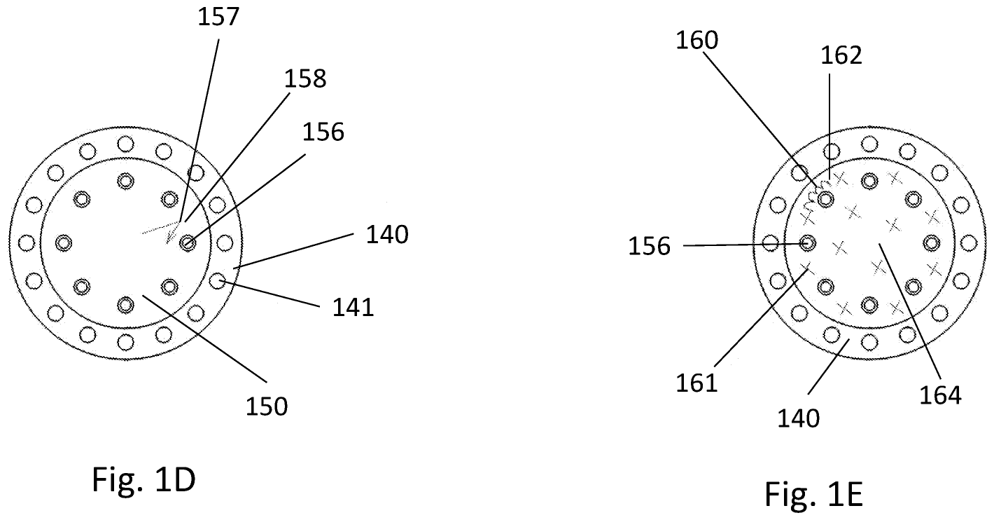

A controlled nuclear fusion system is described below in conjunction with FIGS. 1A-4. Referring to FIGS. 1A and 1B, a tokamak system 100 includes a tokamak vacuum chamber 140 that has a closed-loop tubular shape. The tokamak vacuum chamber 140 can be evacuated and refilled with Deuterium, Tritium, or/and other gases. The tokamak system 100 includes toroidal electromagnet coil 130 wound around the tokamak vacuum chamber 140 and distribute around the vacuum chamber loop. The toroidal electromagnetic coil 130 is formed by an electrically conductive wire that can carry an electric current to produce strong closed loop magnetic flux along the tokamak vacuum chamber 140 to confine electrons and ions. The inner poloidal magnet coils 110 can induce electrical current inside the tokamak vacuum chamber 140 to produce a plasma. The outer poloidal magnetic coils 120 can add a twist to the closed loop magnetic flux formed by the toroidal electromagnetic coils 130 and to improve the plasma stability, and internal wire cage 150 is placed inside the tokamak vacuum chamber 140 and can be electrically biased against the tokamak vacuum chamber 140.

Referring to FIG. 1C, the electrode cage 150 can be formed by a set of wires or tubes in a donut shape. The electrode cage 150 can also include conductive electric coil 156 with support rings 155 to form a rigid structure, with a gap 153 between coil-in 151 and coil-out 152 as shown in FIG. 1C. The conductive electric coil 156 is formed in a toroidal shape. The electrode cage 150 is placed inside the Tokamak supported by insulating support legs 154. The electrode cage 150 can have a bias voltage relative to the wall of the vacuum chamber 140. The bias voltage can be negative or positive, static or alternating, relative to the tokamak vacuum chamber 140. The electrode cage 150 can be electrically isolated or connected to the vacuum chamber walls 140 (without a bias voltage to the vacuum chamber 140). The optional gap 153 is to reduce the induction current by the inner poloidal magnetic coil 110. There can be large current from coil-in 151 and coil-out 152 to form additional magnetic field similar to that of the outer poloidal magnetic coils 120 in some embodiment.

Referring to FIGS. 1D and 1E, the electrode cage 150 is electrically conductive in most or all parts. The electrode cage 150 can be formed by an electric coil 156. A bias voltage can be applied to all or sections of the electric coil 156. The donut shaped electrode cage 150 forms an equal potential surface in the presence of a magnetic field 161 inside the Tokamak vacuum chamber 140. By reducing the surface area if individual electric coil 156 in the electrode cage 150 compared to the interior wall of the tokamak vacuum chamber 140, less ions and electrons are lost. A plasma 164 is formed inside the electrode 150 and the electric potential of the plasma 164 floats with the voltage of the electrode cage 150. When ions or electrons from intense plasma region 164 leave electrode cage 150, they are either repelled or attracted by the electrical field between electrode cage 150 and vacuum chamber wall 140. When the electrode cage 150 is negatively biased to the tokamak vacuum chamber 140, the electrode cage 150 assists to the trapping of ions in the plasma in addition to the closed loop magnetic flux formed by the toroidal electromagnetic coils 130. Most ions 157 in the plasma will bounce off the potential region 158 between the electrode cage 150 and vacuum chamber walls 140 without losing much energy (FIG. 1D). Even though a negative potential on the electrode cage 150 will attract more ions to the electric coil 156 from vacuum chamber 140 and the center plasma region, the overall loss of ions to the vacuum chamber 140 can be less as long as a continuous potential surfaces are formed to bounce off or reflect the ions. When the electrode cage 150 is positively biased to the tokamak vacuum chamber 140, the electrode cage 150 helps to confine electrons in the plasma inside the electrode cage 150. The electrons in the plasma are mainly trapped by the closed loop magnetic flux formed by the toroidal electromagnetic coils 130 and the electrons inside the electrode cage 150 can be bounced by contoured electric potential surfaces formed by the electrode cage 150.

In some embodiments, the bias voltage of the electrode cage can be rapidly switched to attract ions to the vacuum chamber walls 140 and then repel the ions before the ions reach the vacuum chamber walls 140 to reduce loss of ions. Electrons have much smaller mass and can move rapidly without magnetic field confinement, the strong magnetic field near the vacuum chamber walls 140 can significantly increase the path of electrons and the time it takes electrons to reach the walls 140. It is possible to have the right frequency of the bias voltage between electrode cage 150 and vacuum chamber walls 140 to trap both electrons and ions.

Engineering method such as placing insulators between vacuum chamber 140 and the electric coil 156 can further reduce ions that can reach the electric coil 156. The trapping of electrons 160 by the magnetic field 161 will reduce the loss of electrons to the tokamak vacuum chamber 140, ionize molecules in its path, and generate a stable plasma 162. The bias voltage on the electrode cage 150 reduces loss of ions to the walls of the vacuum chamber 140 and can generate new ions and electrons between the tokamak vacuum chamber 140 and the electrode cage 150 to sustain the plasma. The wires or tube cage can also have large current to induce plasma directly and input energy more efficiently. The acceleration of ions from outside the electric coil 156 into the cage is another way to inject large amount of energy into the plasma (FIG. 1E), the close proximity of ion generation regions to plasma regions reduces bending of ions and loss of ions before reaching the center region of the plasma 164. The accelerated ions toward center region of the plasma 164 also increase the chance of head-on collisions between ions and increase the chance of nuclear fusion. In addition, the donut shaped cage may have a substantially higher temperature than the vacuum chamber walls and act as a radiation buffer to reduce the radiation heat loss.

In some embodiments, the toroidal electromagnetic coils 130 can be located inside the tokamak vacuum chamber 140. The electrode cage 150 is inside the toroidal electromagnetic coil 130. In other words, the tokamak vacuum chamber 140, the toroidal electromagnetic coil 130, and the electrode cage 150 all have toroidal shapes and are nested inside each other like Russian dolls. This design has the benefit confining the plasma in the center portion of the tokamak vacuum chamber 140. This design enables the tokamak vacuum chamber 140 to have increased dimensions relative to the electrode cage 150 to further localize the plasma and reduce plasma loss at the walls of the tokamak vacuum chamber 140. Additionally, the toroidal electromagnetic coils 130 can be made of superconducting materials to increase magnetic strength.

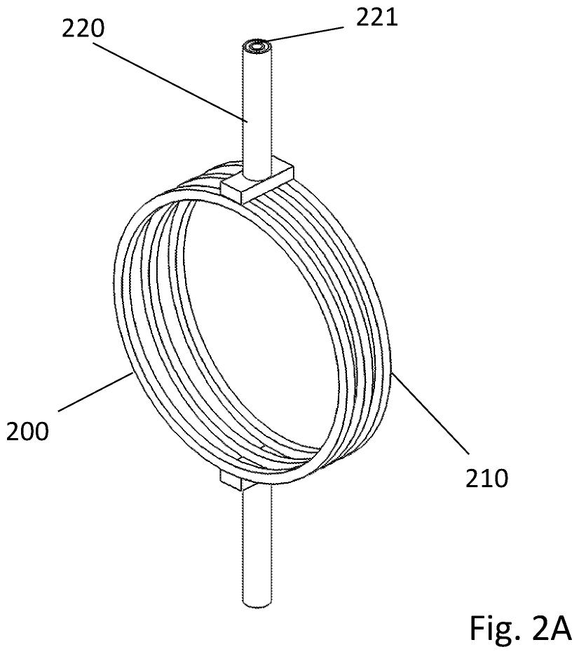

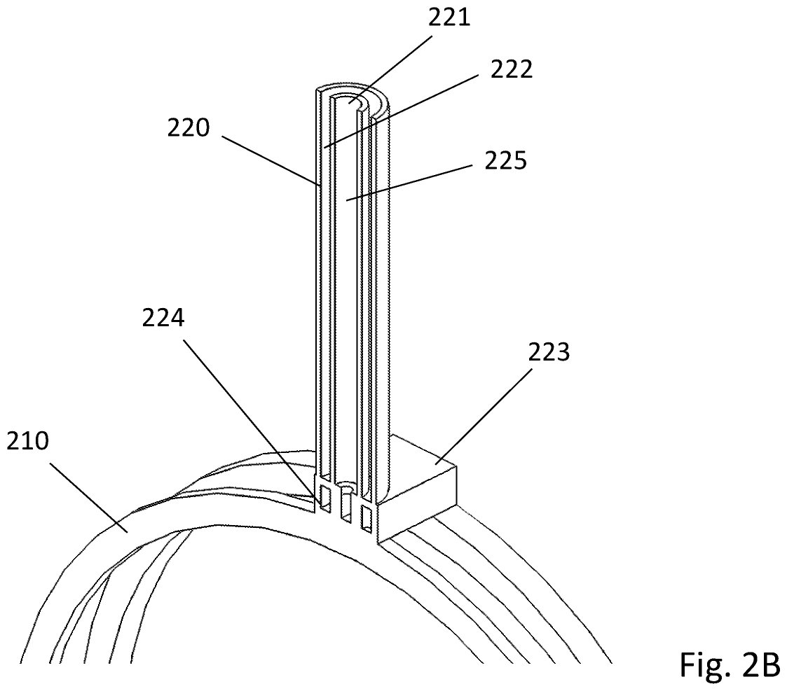

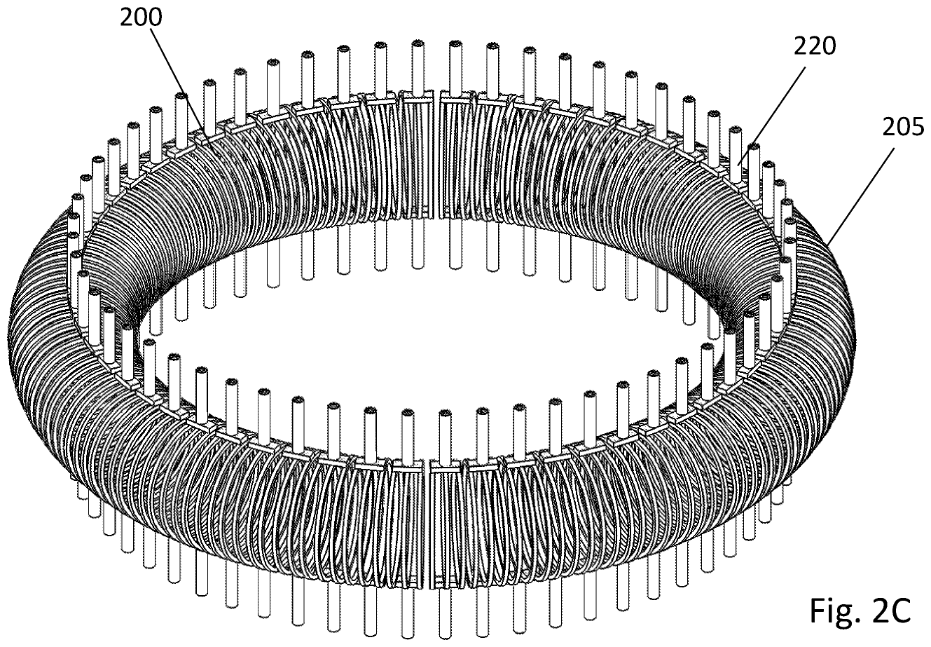

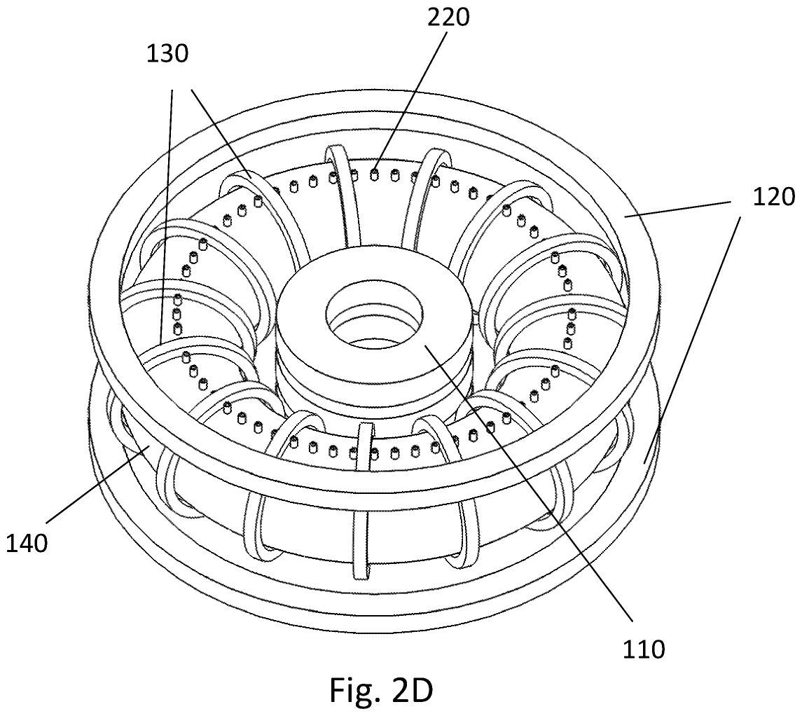

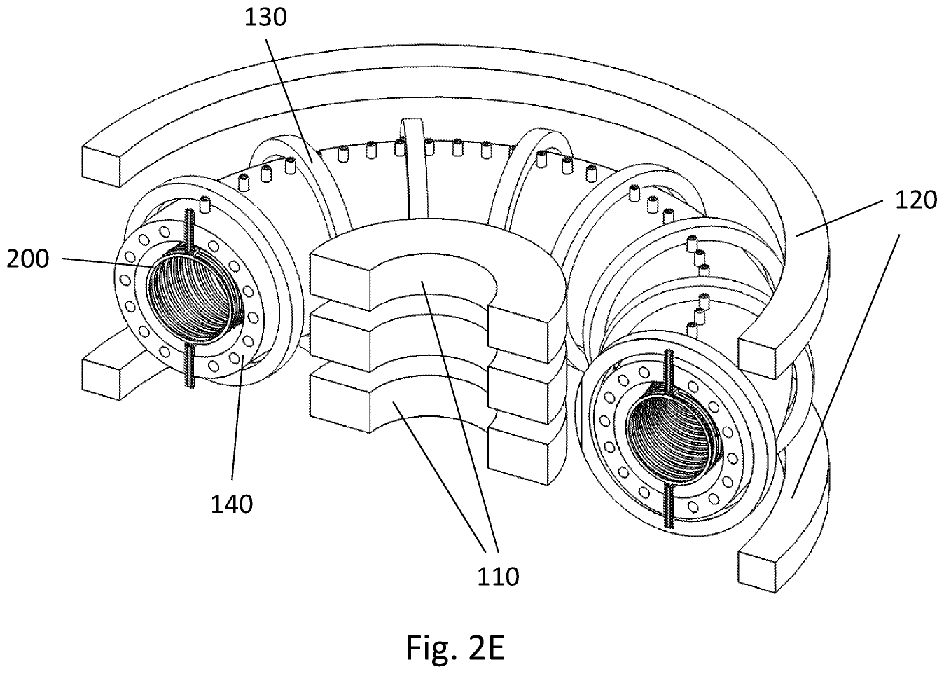

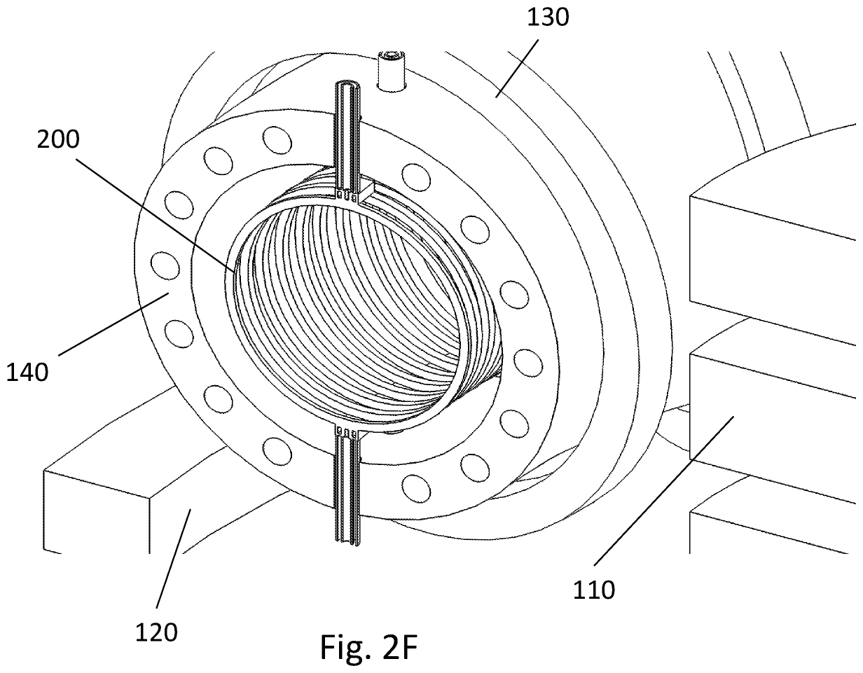

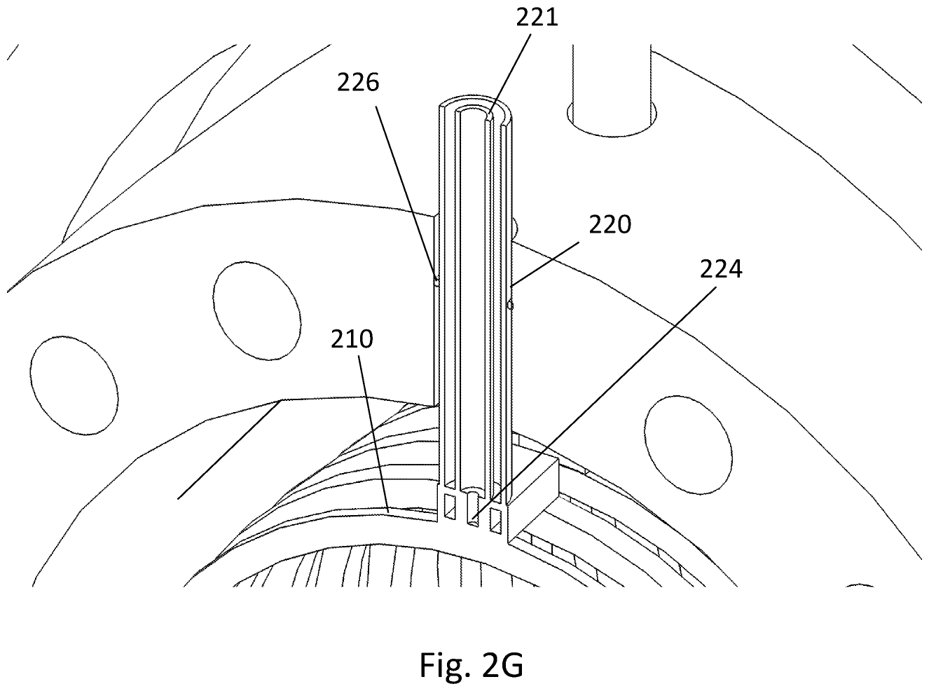

In some embodiments, referring to FIGS. 2A and 2B, to minimize the loss of induction energy, the electrode cage 150 can be made up by a plurality of separate looped electrode 200. These loop ring 210 can be open to allow a current to pass through to generate magnetic fields or closed as shown. The loop ring 210 can be liquid cooled in its entirety or just cooled at the cooling block 223 as shown. An electrical connection 221 and liquid cooling are shown in detail in FIG. 2B, where the electrical connection 221 and vacuum sealing surface on an insulating sleeve 220 are kept at lower temperature. There is an insulating sleeve 220 to prevent electrical short between the looped electrode 200 and vacuum chamber 140. The liquid cooling fluid go in the channels 222 to cool the cooling block 223 through cooling channels 224 and go out from the channel 225. The loop ring 210 is cooled by connecting with the cooling block 223. Alternatively, there can be cooling channel inside the loop ring 210 and cooling fluid can flow through the entire loop ring 210 to improve the cooling. In some embodiments, referring to FIG. 2C, a plurality of individual looped electrodes 200 can be placed successively in a circle to form a toroidal-shaped electrode cage 205.

The electrode cage 205 or the electrode cage 150 (in FIGS. 1A-1C) can be placed inside the Tokamak vacuum chamber 140 as shown in FIGS. 2D-2F, the looped electrodes form a smooth continuous equal electrical potential on and around these looped electrodes. Optionally, by passing currents through each looped electrode, there can be a closed loop magnetic field surrounding the central axis of the Tokamak. Super conducting coils can be inside a looped electrode 200 and still insulated by many layers of insulations and cooled, this current can provide more direct control of magnetic field since the coil location is no longer constrained by the envelope of the vacuum chamber 140. This magnetic field is similar to that generated by the toroidal electromagnet coils 130 externally. FIG. 2G shows details of vacuum sealing with an O-ring 226 and a cooling mechanism similar to what is shown in FIG. 2B.

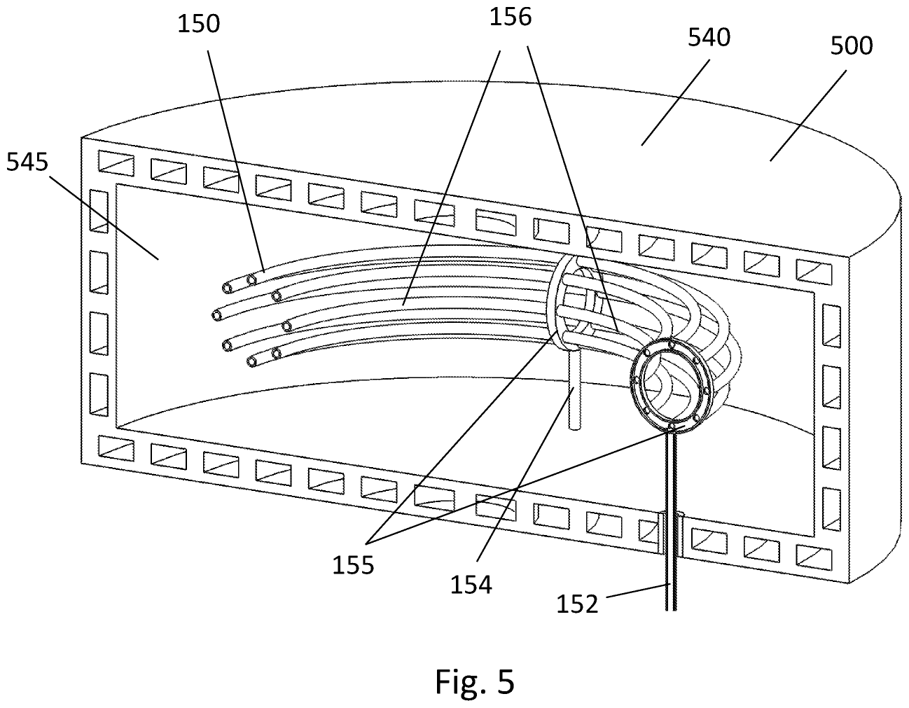

In some embodiments, the toroidal electromagnetic coils 130 can be located inside the tokamak vacuum chamber 140. The electrode cage 205 consists of looped electrode 200 are inside the toroidal electromagnetic coil 130. In other words, the tokamak vacuum chamber 140, the toroidal electromagnetic coil 130, and the electrode cage 205 are nested inside each other like Russian dolls. The electrode cage 205 and the toroidal electromagnetic coil 130 have toroidal shapes, but the outside vacuum chamber can have other shapes such as a cylindrical shape (shown in FIG. 5 discussed below). This design has the benefit confining the plasma in the center portion of the tokamak vacuum chamber 140. This design enables the tokamak vacuum chamber 140 to have increased dimensions relative to the electrode cage 205 to further localize the plasma and reduce plasma loss at the walls of the tokamak vacuum chamber 140. Additionally, the toroidal electromagnetic coils 130 can be made of superconducting materials to increase magnetic strength.

It should be noted that although the tokamak vacuum chamber 140 can be inside or outside of the toroidal electromagnetic coil 130, the toroidal electromagnetic coil 130 is always coiled around outside of the electrode cage 205 as shown in FIGS. 1B and 2E.

In some embodiments, the toroidal electromagnetic coils 130 can be inside or be part of some or all looped electrode 200. The outside surface of the looped electrode 200 can be electrically biased against the vacuum chamber 140, grounded, or floating.

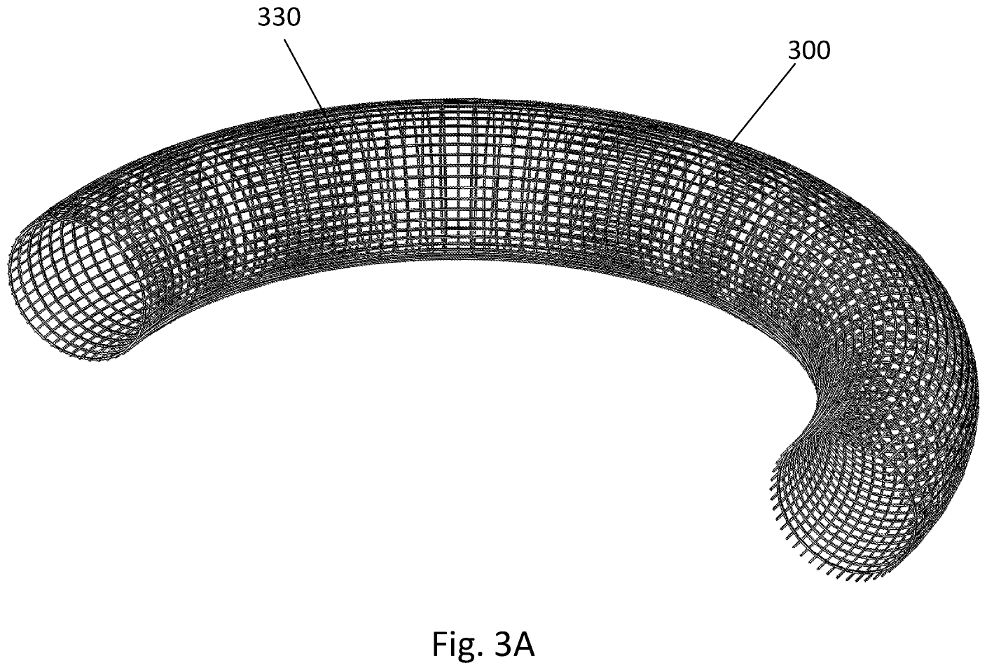

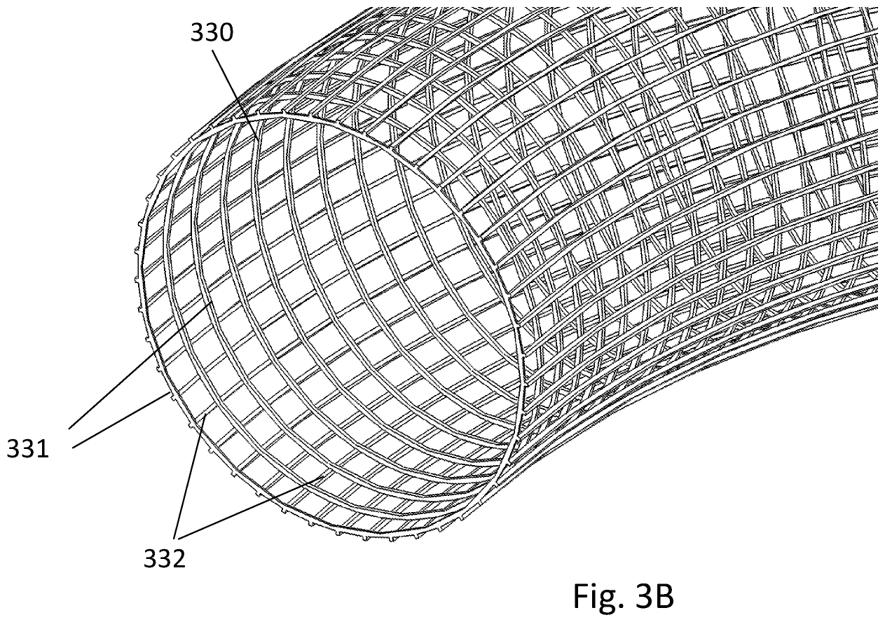

In some embodiments, referring to FIGS. 3A and 3B, the individual looped electrodes can be replaced by a toroidal-shaped mesh 330 to form an electrode cage 300 compatible with the previously described tokamak system. In one implementation, the whole toroidal-shaped mesh 330 in FIG. 3A can be made of high temperature conductive material. Alternatively, as shown in FIG. 3B, the toroidal-shaped mesh 330 can also be made of conductive wires 331 and insulating wires 332 to prevent induced current by external magnet coils. For example, the insulating wires 332 can be made of a ceramic material. The conductive wires 331 and the insulating wires 332 are crisscrossed. The conductive wires 331 are aligned parallel to each other and each of the conductive wires 331 forms a looped electrode as described above. The insulating wires 332 can be intersecting or perpendicular to the conductive wires 331 in the toroidal-shaped mesh 330. The conductive wires 331 in the electrode cage 300 can be supported by similar components (e.g., 220, 221, 222, 223, 224, and 225) shown in FIG. 2B, electrically biased against the vacuum walls 240 by the electrical connections 221 in FIG. 2B and partially cooled. The toroidal-shaped mesh 330 is to replace the individual looped electrodes 200 in FIG. 2C and installed within the walls of Tokomak vacuum 140 in FIGS. 2E and 2F. The advantage of the mesh donut is the smaller gaps between wires to form a smoother electrical potential surface, reduced shielding of the electrical fields by space charges in the plasma, and/or allows higher density plasma.

The above-described embodiments can be used together with magnetic field configurations and induction mechanism of various magnet coils in Tokamak. The region between the wire or tube cage and the vacuum chamber wall is very suitable for generating ions and electrons. The electrons are confined by closed-loop magnetic fields parallel to the wire or tube cage until the electrons ionize gas molecules. These positive ions are pulled into the wire or tube cage by the bias voltage between the wire or tube cage and vacuum chamber walls and provide a source of ions to stabilize plasma. The bias voltage also prevents most ions inside the cage from reaching the vacuum chamber walls. The strong magnetic field will reduce the number of electrons or reduce the energies of the electrons that reach the vacuum walls. In addition, in a thermalized plasma inside the Tokamak, the energy of each electron may be much less than that of ion, assuming the electron and ion have similar velocity, and the energy loss of the plasma is mainly due to ion losses to the vacuum chamber walls. By providing a very efficient plasma generation and stabilization mechanism, the present invention improves the plasma stability of the conventional Tokamak and adds another mean to input energy to the plasma. By having a much smaller physical surface on the wire or tube cage and by preventing ions from reaching vacuum chamber walls, the present invention reduces the loss of ions to vacuum chamber walls. The additional voltage will accelerate some electrons to the vacuum chamber walls, the strong magnetic fields and light mass of the electrons will confine the electrons much longer, causing the electrons to lose energy to the plasma and not adding significant total loss of the plasma energy to vacuum chamber walls.

The surface temperature of the wire or tubes can be significantly higher than the vacuum chamber surface, since the vacuum chamber wall temperature is limited due to maximum thermal expansion allowed, vacuum sealing requirement, and lack of vacuum isolation between vacuum chamber and the surrounding environment in air. The higher temperature wire or tube cage will act as a buffer to reduce the radiation heat loss of the plasma. Since the radiation heating is proportional to the 4th power of absolute temperature, an intermediate layer at temperature T between plasma and vacuum chamber wall at temperature Tw can reduce radiation loss by σ(T⁴-Tw⁴) A, where σ=5.67×10⁻⁸ J/s·m²·K⁴ is the Stefan-Boltzmann constant and A is the surface area of the intermediate area, assuming the emission coefficient is 1. If T=3000K, and Tw is 800K, the radiation loss is reduced by approximately 4.57 MJ/s/m², which is very significant. The heat radiation from the wire or tube cage to vacuum chamber walls is caused by the radiation and plasma heating of the hot plasma and does not increase the total energy loss.

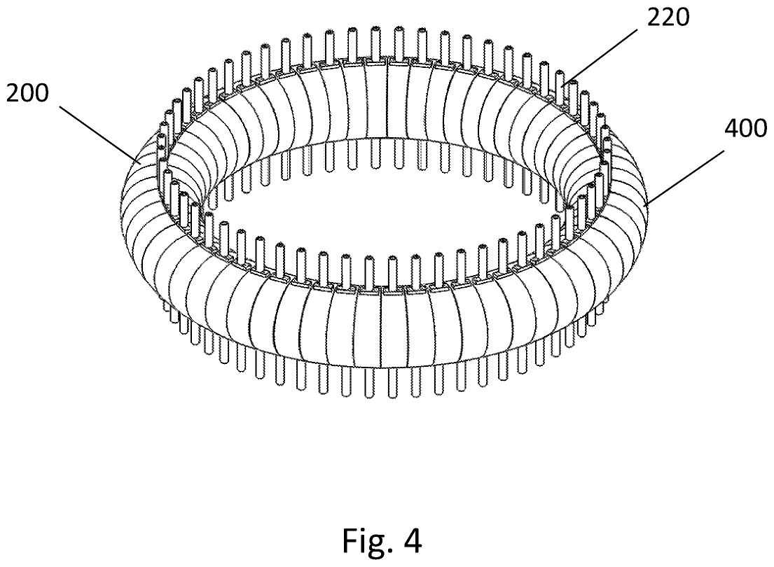

In one implementation, referring to FIG. 4, an electrode cage 400 compatible with the previously described tokamak system can form a substantially closed surface by either thermal expansion, close proximity of the cathode loops 200 to each other, or overlapping individual parts without electrically contacting each other. The individual parts can be electrically insulated by an insulating material in between. In this implementation, there is no need for electrical connections and the insulating sleeves are for mechanical support, and liquid cooling. By only providing enough cooling to prevent the melt of the materials, the cage can be at high temperature and reduces the radiation loss. The reduction in radiation loss can potentially push the Tokamak into net energy gain.

The voltage and current on the electrical coil can be adjusted at various stages of the operation to avoid excess amount of heating and loss of plasma. There is no need to pass a current to generate a magnetic field in the wire or tube cage, if there is strong magnetic field present from the Toroidal coils in Tokamak, simplifying the power supplies requirement. The vacuum chamber can be biased, and the wire or tube cage can be near ground potential. In extreme case, the coils in present invention can have similar electrical potential as the vacuum chamber walls and away from the most intense region of the plasma in the Tokamak. The induction heating of plasma by an electrical coil inside the vacuum chamber reduces energy losses to the chamber wall and other type of conductors.

Referring to FIGS. 1C and 5, an exemplified nuclear fusion system 500 includes a vacuum chamber 540 and an electrode cage 150 inside the vacuum chamber 540. The vacuum chamber 540 has less interior surface area 545 than the interior surface of the Tokomak vacuum chamber 140 shown in FIGS. 1A to 1E. If there are means to create similar magnetic confinement inside the vacuum chamber 540, there would be less plasma losses to the vacuum chamber walls, at least to the inner diameter side where there is no wall. On the other sides, the interior surface 545 of the vacuum chamber 540 can be further away from the hot plasma region 164 of FIG. 1E since the vacuum chamber walls are no longer required to be inside the Toroidal magnets. The longer distance between the interior surface 545 and the hot plasma region can reduce plasma loss to the walls and energy loss of the hot plasma. Ions can bounce off the potential field and away from chamber walls to reduce the energy loss. Electrons have much longer path to reach vacuum chamber surface and ionize the plasma.

In some embodiments, a plurality of looped electrodes in FIG. 2C can be installed within an open-space vacuum chamber similar to 540 in FIG. 5, replacing the electric coil 156, the coil-out 152, and the support ring 155. This configuration can reduce plasma losses to the walls. Conducting or superconducting coils inside some or all looped electrodes 200 can create a closed loop of magnetic flux similar to the magnetic flux created by the toroidal electromagnetic coils 130 in FIGS. 2D-2F, there can still be outer poloidal magnet coils 120 and the inner poloidal magnet coils 110, even though the placement may be different. The direction injection of ions and plasma energy from vacuum chamber walls 545 towards the looped electrodes 200 reduces to reliance on the induction heating of the plasma by the inner poloidal magnet coil 110.

Only a few examples and implementations are described. The electrode cage can be negatively biased against the vacuum chamber in most instances, the electrode cage may also be positively biased or not biased against the vacuum chamber and still form a plasma. The polarity and magnitude of the voltage bias of the electrode cage can be optimized for the maximum energy efficiency in each specific nuclear fusion system. The inner surfaces of vacuum chamber and the surfaces of electrode cage that face plasma can be partially or completely covered by insulators or other materials that can stand high temperature. Partially covered conductive surfaces can still form an electrical potential surface to inject energy or to prevent ions or electron loss. The self-bias voltage on insulator surfaces by plasma may also help plasma confinement. Plasma can be influenced by the electrical potential formed by the voltage underneath the insulators. Voltages on insulator surfaces can still be induced by radio frequency (RF) power underneath the insulators, even if the insulators completely cover the conductive surfaces. Other implementations, variations, modifications and enhancements to the described examples and implementations may be made without deviating from the spirit of the present invention.

1. A controlled nuclear fusion system, comprising:
a vacuum chamber;
an electrode cage shaped in a first closed-loop tube in the vacuum chamber, wherein the electrode cage comprises electrically conductive wires configured to confine ions and electrons in the electrode cage; and
a toroidal electromagnetic coil coiled around outside of the electrode cage and configured to produce a closed-loop magnetic flux in the electrode cage.

2. The controlled nuclear fusion system of claim 1, further comprising:
an outer poloidal magnet and an inner poloidal magnet configured to produce a plasma in presence of the closed-loop magnetic flux in the vacuum chamber.

3. The controlled nuclear fusion system of claim 2, wherein the electrode cage includes an input and an output, wherein the input and the output are separated by a gap to reduce induction current by the inner poloidal magnets.

4. The controlled nuclear fusion system of claim 1, wherein the electrode cage is configured to be negatively biased relative to the vacuum chamber to form a potential surface to confine the ions.

5. The controlled nuclear fusion system of claim 1, wherein the electrode cage is configured to be positively biased relative to the vacuum chamber to confine the electrons inside the electrode cage.

6. The controlled nuclear fusion system of claim 1, wherein the electrode cage is electrically connected to the vacuum chamber.

7. The controlled nuclear fusion system of claim 1, wherein the electrode cage is electrically isolated to the vacuum chamber.

8. The controlled nuclear fusion system of claim 1, wherein the electrode cage is configured to be electrically biased relative to the vacuum chamber by an alternating voltage to trap ions and electrons in the electrode cage.

9. The controlled nuclear fusion system of claim 1, wherein the vacuum chamber is shaped in a second closed-loop tube, wherein the second closed-loop tube of the vacuum chamber is nested in the first closed-loop of the toroidal electromagnetic coil.

10. The controlled nuclear fusion system of claim 9, wherein the toroidal electromagnetic coil is coiled around outer surfaces of the vacuum chamber.

11. The controlled nuclear fusion system of claim 1, wherein the toroidal electromagnetic coil is inside the vacuum chamber.

12. The controlled nuclear fusion system of claim 1, wherein the electrode cage comprises a plurality of looped electrodes positioned in a toroidal shape to form the first closed-loop tube.

13. The controlled nuclear fusion system of claim 12, wherein the looped electrodes in the electrode cage include a superconducting material to form the closed loop magnetic flux.

14. The controlled nuclear fusion system of claim 1, wherein the electrode cage is formed by a conducting coil that are positioned in a toroidal shape to form the first closed-loop tube.

15. The controlled nuclear fusion system of claim 1, wherein the electrode cage is formed by a toroidal mesh of crisscrossed conducting wires and insulating wires.

16. The controlled nuclear fusion system of claim 1, wherein the electrode cage is formed by a toroidal mesh of conducting wires.
